(19) United States
(12) Patent Application Publication
(10) Pub. No.: US 2025/0266179 A1
(43) Pub. Date: Aug. 21, 2025

(54) Method and Apparatus to Test for Defects in Irradiated Nuclear Fuel

(71) Applicant: Robert D. Varrin, JR., Reston, VA (US)

(72) Inventor: Robert D. Varrin, JR., Reston, VA (US)

(21) Appl. No.: 18/655,244

(22) Filed: May 4, 2024

Related U.S. Application Data
(60) Provisional application No. 63/554,130, filed on Feb. 15, 2024.

(51) Int. Cl. G21C 17/07; G21C 19/07; G21C 19/32

(52) U.S. Cl. CPC G21C 17/07; G21C 19/07; G21C 19/32

(57) ABSTRACT

An apparatus to test for defects in irradiated nuclear fuel includes a submerged sipping canister, a first recirculation system and a degassing device to remove and discharge pre-existing dissolved fission product gases from the fluid in the system and canister prior to a sipping test, a second recirculation system and a degassing device to extract and detect fission products from the fluid in the canister during the sipping test, a flow control valve to maintain a partial vacuum in the canister when the second recirculation system is operating, and a radiation detector monitoring the output gas from the degassing device. The fluid-contacting surfaces of selected components may be pretreated or modified to reduce adsorption or adherence of radioactive noble gases on wetted surfaces to decrease background radiation levels and contamination of the apparatus. A related method is also disclosed.

### CROSS REFERENCE TO RELATED APPLICATION

This application claims the benefit of U.S. Provisional Patent Application No. 63/554, 130 entitled, “Method and Apparatus to Test for Defects in Irradiated Nuclear Fuel,” filed by the present inventor on Feb. 15, 2024, the entire disclosure of which is incorporated herein by reference.

### BACKGROUND OF THE INVENTION

### Field of the Invention

The invention pertains to apparatus and methods to detect defective nuclear fuel rods, and more particularly, to apparatus and methods for detecting defective nuclear fuel rods using a canister sipping system.

### Description of Related Art

Defective nuclear fuel rods in boiling water reactor (BWR) or pressurized water reactor (PWR) fuel bundles can release radioactive fission products that are normally contained within the hermetically sealed fuel rod cladding. Defects can be caused by foreign object wear, fretting or corrosion. The fission products can be released into the primary coolant circuit of the plant during normal operations, or into a spent fuel pool, other pools such as the fuel cask loading pit, or water-filled cavities (a pool) above the reactor established during refueling. Fission products include Kr-85, Xe-133 and Cs-137. If these fission products are released from the fuel when the plant is offline for a refueling outage, there is an increased risk of contamination of workers at the site as these pools are open to the atmosphere/building spaces above the pool surface. Fission products released into the pools may remain as dissolved species increasing the pool water contamination and background radioactivity. Fuel bundles with defective fuel rods may not be able to be returned to the reactor for a subsequent operation cycle. Fuel bundles with defective fuel rods may also not be suitable for storage in dry cask storage facilities designed for long term storage of fuel that is discharged from the reactor.

The identification of defective fuel can be accomplished when the plant is offline by a process known as sipping. Sipping has been available to the nuclear industry for over 40 years. A good summary of sipping technologies worldwide can be found in https://www.neimagazine.com/features/featurefuel-inspection-systems-4410559.

The irradiated fuel which is subjected to sipping must be always kept underwater to shield workers from radiation emitted by the fuel, and to absorb decay heat generated by the fuel. Thus, sipping systems are also deployed underwater. Typically, fuel is kept around 20 to 30 ft underwater, so sipping systems are also placed underwater at about 20 to 30 ft deep. For fuel that is about 12 ft long, the top of the sipping system may be at 20 ft with the bottom at about 32 ft submerged depth. The hydrostatic pressure at the top of the canister is therefore about 23 psia (8.7 psig), and the pressure at the bottom of the canister is therefore about 28 psia (14.8 psig).

The water in which the sipping system is submerged may be demineralized light water, heavy water or borated light water.

Sipping systems generally fall into two categories: (1) those that reduce the differential pressure between the pressure interior of the fuel rod and the hydrostatic pressure of fluid in which the fuel bundle/rod(s) are submerged, thereby creating a driving force for the higher pressure gases inside the defective fuel rod to diffuse or flow through defects where they can be measured by sampling and testing the liquid surrounding the rods, and (2) those that strip fission gases from the fluid surrounding the defective fuel rods usually by gas sparging.

With regard to the first category, reducing the pressure around the fuel rod can be achieved by raising the fuel bundle vertically to reduce the hydrostatic pressure of the fluid surrounding the fuel rod and assembly. This can be done above the reactor as the fuel is raised out of the core into the refueling mast, which resembles an open bottom cylinder with a closed top. A sample of the liquid in the mast is then taken and measured for activity typically with a scintillation detector. Gas sparging into the bottom of the mast can also be performed with a liquid/gas sample extracted from the top of the mast removed for analysis.

An alternative method for detecting defective fuel is to analyze a liquid sample taken from the fluid surrounding the fuel for non-volatile Cs-137.

A sipping system is described in U.S. Pat. No. 4,034,599. This system includes a sipping canister into which air is sparged at the bottom. This reduces pressure in the chamber now filled with a two-phase air/water mixture, the density of which is lower than water alone. A gas space is formed above the fuel in the canister and is sampled to detect noble gas fission products. The process proceeds with pulling a vacuum on the air space above the fuel while sparging to further reduce pressure in the canister. The extracted gas can be recirculated back into the canister to accumulate fission product gases. The water in the canister is not recirculated.

Another sipping system is described in Japanese Patent JPS63266395. In this apparatus, gas is introduced into the bottom of a canister fitted with a “cap” that collects sparge gas but does not seal the fuel assembly in the canister. Prior to testing, the fluid inside the canister may be treated in a separate vessel in a liquid recirculation loop by sparging the vessel with a non-radioactive gas. As in U.S. Pat. No. 4,034,599, gas is recirculated and radioactive fission products including Xe-133 and Kr-85 are measured with an inline radiation detector.

A third system is described in U.S. Pat. No. 11,170,904. The apparatus includes a water treatment device to first remove radioactive noble gases from the water in the canister using a vacuum gas transfer membrane device to which a sweep gas is supplied to the gas (vacuum) side of the module. The sweep gas is used to carry away any radioactive fission products or other dissolved gases such as air or carbon dioxide in liquid. Air is used as the sweep gas. The exhausted sweep gas is discharged to the environment, typically through the plant's off-gas handling system. Degassing the water lowers the background radiation and improves the signal to noise ratio in the detector. Then, in a separate evolution, conventional vacuum sipping is performed by a separate set of components and involves: (1) addition of gas to the canister to form a bubble above the fuel in the sealed canister, (2) pumping gas from the bubble using a vacuum pump to lower the pressure in the canister, (3) passing the removed gas through an inline radiation detector, and (4) exhausting this gas to the environment. A further embodiment described in the patent uses air sparging to strip radioactive dissolved gas from the fluid in the canister, which is similar to what is described in aforementioned Japanese Patent JPS63266395.

Descriptions of vacuum canister sipping systems can be found on nuclear fuel service vendor websites.

In general, in vacuum canister sipping systems that extract radioactive noble gases such as Xe-133 or Kr-85 from the interior of defective fuel rods by reducing the pressure of the fluid surrounding the fuel, a gas such as air is added to the top of the canister to form a gas space above the fuel. The volume of gas depends on the specific design of the canister but a cylindrically oriented canister 14 inches in diameter (to accommodate a pressurized water reactor (PWR) assembly about 9×9 inches in cross-section with a 6-inch gas space would have a gas pocket volume of 900 in³ (14.7 liters or 14,700 cm³). By contrast, for a typical pressurized water reactor fuel rod with an inner diameter of about 9.2 mm, with fuel pellets that are about 9.1 mm in diameter, the volume of the interior of the rod not occupied by fuel pellets or the “plenum” space about the fuel pellets is only about 15 to 20 cm³.

Gas withdrawn from the gas space above the fuel with a vacuum pump lowers the pressure in the sealed canister (i.e., it creates a partial vacuum). The pressure can be reduced as low as the saturation vapor pressure of the water in the canister, which is about 1 psia (−13.7 psig) at an exemplary spent fuel pool temperature of 105° F. (40° C.) for non-borated water. More typically, the pressure is reduced to about 2.5 to 3 psia (−12.2 to −11.7 psig).

A 14-inch diameter vacuum sipping canister 14 ft in height, tall enough to accommodate a 12 ft long fuel assembly, would have a volume of about 100 gallons (about 380 liters). The volume of fluid (e.g., water) displaced by the fuel assembly is about 20 gallons (about 75 liters) leaving a net fluid volume of about 80 gallons (about 300 liters) during a sipping test.

Alternatively, systems can reduce pressure around the fuel rods by sparging the canister with gas, with the canister fluidically connected to the atmosphere above the surface of the pool of water in which the canister is submerged. The percent of gas or void fraction in such a sparged column is typically 3 to 25% (also known as hold-up). Given that the density of an ideal gas is about 0.1% of the density of water, the pressure at 25% void fraction would be about 25% less than if no sparging were performed. The fluid (e.g. water) inside the upper end of the canister would be at about 11 psia (−3.7 psig) if the canister is fluidically connected to the atmosphere above the water surface into which the canister is submerged by a conduit such as a tube or pipe. This reduction in pressure is less than that which can be achieved by establishing vacuum conditions in the gas bubble in vacuum canister sipping, or about 1 psia (-13.7 psig) as stated earlier.

Despite reports of good performance of existing sipping systems, several instances have been reported where existing systems failed to detect small defects in fuel rods [see US Nuclear Regulatory Commission Information Notice 2018-01, dated Feb. 21, 2018 entitled “Noble Fission Gas Release During Spent Fuel Cask Loading Operations”].

Sipping campaigns may also form part of what is known as the “critical path” during a refueling outage so efficient sipping tests that do not prolong the refueling outage schedule are therefore very desirable.

Further, as discussed in U.S. Pat. No. 4,034,599 contamination, the adsorption or absorption of fission products on surfaces of the sipping equipment, should be avoided to prevent background dose rates from increasing and also facilitate removal of the system from the pool after a campaign without radiation exposure or contamination of workers as a result of handling the equipment.

There are several limitations of existing sipping systems including vacuum canister sipping systems. Among the limitations is that the introduction of gas into the system to allow either a vacuum to be pulled on the gas space at the top of the canister, sparging to reduce fluid (e.g., water) pressure due to gas “hold-up”, or sparging to strip fission gases from the fluid surrounding the fuel, will dilute the concentration of any radioactive fission products released from defective fuel. Further, in conventional vacuum sipping systems, the release of trapped fission products from a defect in fuel in the form of bubbles means that the bubble must rise to the gas space at the top of the canister, which can take 10 minutes or more for small bubbles. The diffusion of dissolved radioactive gas species from the defect location to the free surface of a static or non-sparged vacuum canister sipping system can take many days or even weeks. The time required to sequentially complete the steps of adding gas to a vacuum sipping system, pulling vacuum, and then sampling the gas can take 10 minutes or more. The steps of loading the fuel assembly into the canister, removing background fission products as incorporated into some systems, the sipping test itself and refilling the canister prior to removing the fuel can take more than 10 minutes as well, which can limit the rate at which fuel can be offloaded from the reactor if sipping is performed during a refueling outage. Finally, as discussed in other prior art, reducing background radiation levels attributed to dissolved noble gas fission products from the fluid in the sipping system, is desirable, but so too is the prevention of adsorption of fission products on wetted surfaces and attachment of bubbles to these surfaces, the release of which can increase background radioactivity or increase the potential for contamination of the system during the sipping campaign at a plant.

What is needed, therefore, is a way to combine the attributes of the pressure reduction system with some way to reduce background radioactivity of the fluid in the canister, and at the same time avoid or reduce the use of sparge gas.

### Objects and Advantages

Objects of the present invention include the following: providing an improved sipping system for detecting defects in nuclear fuel elements; providing a sipping method that reduces the time needed to examine a fuel assembly; providing a sipping system that reduces the use of gas that would dilute the target gases, thereby improving sensitivity; providing a sipping system that improves the sensitivity of detecting defective fuel by reducing the potential for contamination of sipping equipment; and, providing a fuel inspection system that reduces the radiation exposure of operating personnel.

### BRIEF SUMMARY OF THE INVENTION

According to one aspect of the invention, a canister sipping system comprises:
a canister to hold a nuclear reactor fuel rod assembly submerged in an aqueous fluid;
a first recirculation system to pump fluid from the canister through a gas transfer membrane module to strip the fluid of pre-existing radioactive gases, in which:
   a gas conduit including a pump and valve directs gas from the gas transfer membrane module to a radiation detector to monitor the progress of removing the pre-existing radioactive gases;
a second recirculation system to pump the degassed fluid through a gas transfer membrane module, in which:
   the second recirculation system includes a restrictor valve between the pump outlet and the canister on the high pressure (high-P) side, thereby creating a partial vacuum in the canister to extract radioactive gases from any defective fuel rods, and,
   a valve and gas conduit directs gases from the gas transfer membrane module to a radiation detector when the second recirculation system is operating, in order to monitor any increase in radioactive gases extracted from defective fuel elements by the partial vacuum.

According to another aspect of the invention, a method for detecting defects in a nuclear fuel rod assembly comprises the steps of:

a) placing a fuel rod assembly vertically in a closed, water-filled container;
b) establishing a first recirculation loop to pass the canister water through a gas transfer membrane module to remove pre-existing radioactive gases from the water;
c) pumping gas from the gas transfer membrane module to a radiation detector to monitor the progress of removal of pre-existing radioactive gases;
d) after removal of the pre-existing radioactive gases, establishing a second recirculation loop including a pump and a restrictor valve so that the canister is on the low-pressure (low-P) leg and the gas transfer membrane module is on the high-pressure (high-P) leg;
e) pumping gas from the gas transfer membrane module to a radiation detector; and,
f) evaluating the level of fuel defects based on the level of radioactivity detected in the gas.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of the canister sipping system according to an example in which pressure in the canister is reduced by partially closing a valve upstream of the canister, the valve being part of a recirculation system, while detecting radioactive fission gases extracted from the recirculating fluid in a gas removal system with an inline radiation detector.

FIG. 2A is a schematic diagram of the first recirculation loop operating to remove pre-existing radioactive gases from a canister sipping system in an open loop once-through mode in accordance with some aspects of the invention.

FIG. 2B is a schematic diagram of the first recirculation loop operating to remove pre-existing radioactive gases from a canister sipping system in closed loop recirculation mode in accordance with some aspects of the invention.

FIG. 3 is a schematic diagram of the second recirculation loop operating to capture and detect newly released radioactive gases in a canister sipping system in accordance with some aspects of the invention.

FIG. 4 is a schematic diagram of the operating steps according to one example of the inventive method.

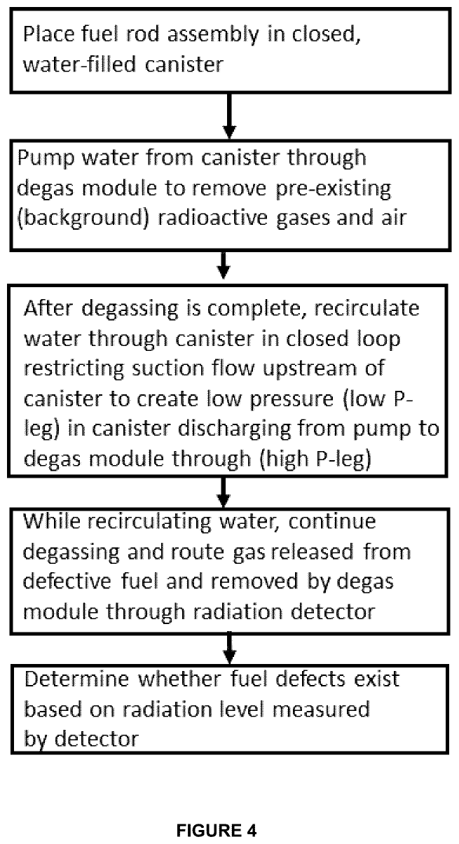

### DETAILED DESCRIPTION OF THE INVENTION

The invention provides a means to reduce the pressure of the fluid in a sipping canister without sparging or requiring the steps of: (1) injecting gas into the canister to form a bubble or gas space at the top of the canister, (2) removing a portion of the gas using a vacuum pump to reduce the pressure in the canister, and then (3) directing a gas sample from the top of the canister to a radiation detector. More specifically, gas addition is avoided, and hence so too is dilution of the fission products, as the canister remains filled with fluid (a so called “solid system”) while the fluid is recirculated through the canister with a lid closed using a recirculation loop, with a pump downstream of the canister and a valve upstream of the canister. The valve upstream of the canister is partially closed while the pump is operating to recirculate the fluid, increasing the pressure drop across the valve and therefore decreasing the pressure in the canister, and thus the pressure of the fluid surrounding the fuel. The pump suction-induced pressure decrease in the canister is almost immediately achieved upon partially closing the valve due to the incompressible nature of the fluid (e.g., water). Released radioactive fission products as dissolved species or bubbles are conveyed through the recirculation system by forced convection.

The system described herein reduces pressure in a sealable canister into which fuel has been placed and then detects radioactive fission products extracted from a fluid recirculation loop receiving fluid from the canister. In this description, the word “fluid” and “water” may be used interchangeably, and it will be understood that “water” may refer to normal water of any selected purity, aqueous solutions such as borated water, or heavy water, as nuclear power systems may have any or all of these at various places in their processes.

### Example

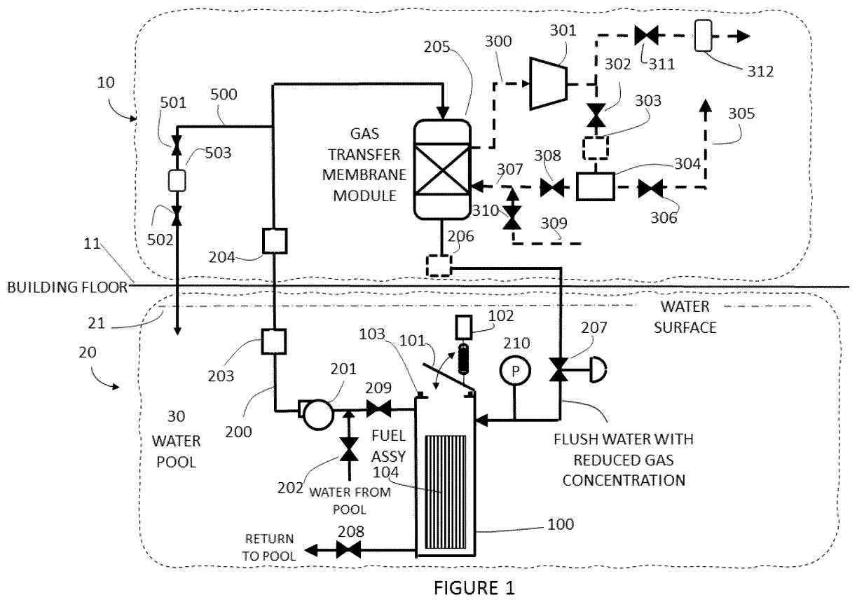

FIG. 1 illustrates a sipping system according to an embodiment of the present invention. Components 10 of the system are located above a pool surface and placed on the building floor 11. Underwater components 20 are submerged below the pool surface 21 in water pool 30. The system includes canister 100, with a lid 101 opened and closed with an actuator 102; leak tight seals 103 are preferably a compliant elastomeric material. A fuel assembly 104 is placed vertically into the canister for leak testing.

A fluid recirculation system 200 consisting of a pump 201, an in-line filter 203, a flowmeter 204, a pressure gauge or transducer 210, an optional cooler 206 and one or more valves including a flow control valve 207 and canister outlet valve 208. It will be appreciated that while the canister 100 should be located below the water pool surface for shielding purposes when fuel is in the canister, other components such as filter 203 could be located above the water surface as part of components 10 to facilitate maintenance or filter replacement. Integral to the recirculation loop is a hollow fiber gas transfer membrane module 205. The in-line filter 203 removes particulate material from the recirculation fluid that might otherwise clog or foul gas transfer membrane module 205 (see for example filtration recommendations in DuPont Product Data Sheet DuPont™ Ligasep™ Degasification Modules Models LDM-120-HS, LDM-120-LS which specifies total suspended solids should be less than 1 ppm and 3M “Inlet Water & Sweep Gas Guidelines for 3M™ Liqui-Cel™ Membrane Contactors Rev dated April 2021 available at www.3m.com/Lqui-Cel which specifies an inlet filter no greater than 5 μm rating). The optional cooling can help remove decay heat emanating from the fuel assembly. The cooler may be a submerged finned heat exchanger located below water surface 21 but transferring heat to the pool water 30. The recirculation loop includes an inlet line and valve 202 upstream of the pump that allows water from the pool to be passed through the recirculation system when operated in an open loop “once-through” mode in which water is returned to the pool discharge line and valve 208 after passing through the canister to flush the canister 100 with degassed fluid. In the gas transfer membrane module 205, a vacuum is applied to the inside or lumen side of the hollow fiber membrane module to extract dissolved gases from the fluid passing through the shell side. The vacuum system 300 includes a vacuum pump or blower 301, an optional dryer 303, e.g., a chiller, a radiation detector 304, an exhaust line 305 which can be isolated with valve 306, and a return line 307 which can be isolated with valve 308. The return line 307 can be used to recycle the gases removed from the liquid back to the gas transfer membrane module 205 when the exhaust is isolated by closing valve 306. Removed gases and any “sweep” gas used can be exhausted through line 305 by opening valve 306 and closing valve 308. Incorporated into the gas loop 300 is a gas supply line 309 and gas admission valve 310. The source of pressurized gas may be a gas cylinder or a compressor, not shown in FIG. 1. Sweep gas, which can improve the efficiency of removing dissolved gases from the fluid on the shell side of the gas transfer membrane module, can optionally be supplied through line 309 which can be isolated with valve 310. Valve 310 can also be used to control the mass flow of sweep gas. The gas supply can also be used to initially fill the system or purge the system with non-radioactive gas prior to a sipping test. The recirculation system may also optionally include a liquid sampling system 500 with a sample vessel 503 and isolatable with valves 501 and 502. During flushing or filling of the sample vessel, fluid is discharged back to the pool 30. The sampling system can also include a sample vessel 503 filled with an ion-exchange or absorbent media 504 which absorbs Cs-137, such as a crystal silicotitanate (CST).

Optionally, the system can be configured to allow for introduction of gas to the canister 100, to create a gas space above the fuel bundle, and thereafter operate as a conventional vacuum canister sipping system with a vacuum pump/gas sampling/radiation detector connected to the top end of the canister 100 or lid 101.

### Example

Operation of the system is preferably carried out as follows:

Step 1. A fuel assembly 104 is placed in canister 100 whereupon the lid of the canister 101 is closed using actuator 102 or by relying on gravity, wherein the lid engages seals 103 to create a leak tight seal.

Step 2. A fluid degassing procedure is performed to remove dissolved gaseous radioactive fission products present in the pool 30 water and in the water in the canister 100 that has been filled with pool water. Radioactive fission gases in the water are due to leakage from defects in other fuel assemblies currently or previously placed or stored in the pool. The degassing procedure lowers the background radiation of the fluid in the sipping system including the canister. The degassing procedure also removes dissolved air from the water, the volume of which upon removal is significantly greater that the volume of gas interior to a fuel rod if the water in the canister and recirculation system are saturated in air (e.g., greater than 10,000 cm³ dissolved air for a 300-liter sipping system as compared to about 15-20 cm³ of gas inside a fuel rod).

The degassing procedure may be formed in one of two methods, the first being referred to as an open loop “once-through” method, the second being a closed loop recirculation method. In the once-through method, water from the pool 30 is passed over the fuel assembly and discharged back to the pool which removes decay heat from the fuel assembly as the pool volume is typically very large (e.g., >100,000 gallons) as therefore serves as a large heat sink. In recirculation mode, the temperature of the recirculating water in the “solid system” could increase due to decay heat.

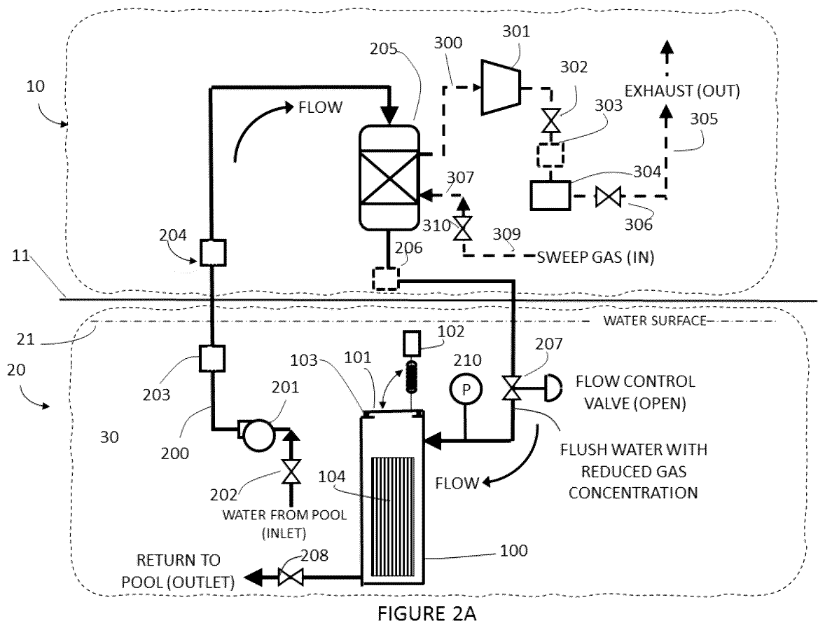

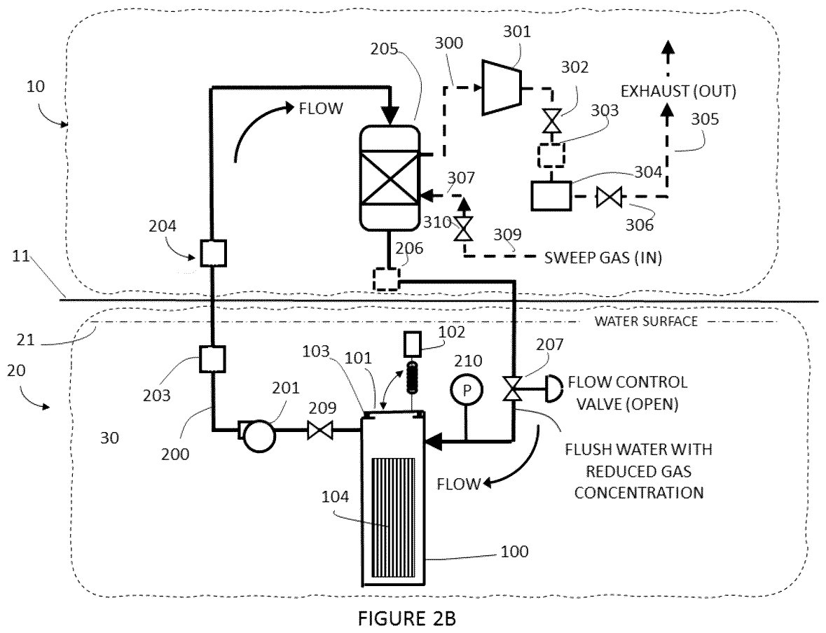

Referring to FIG. 2A, the degassing procedure in once-through mode is performed comprising the steps of opening valve 202 to provide a source of pool water, opening valve 207 to establish a path to admit degassed fluid to the canister, opening valve 208 to provide a discharge path for degassed water out of the canister, operating fluid pump 201, and applying vacuum to the lumen (gas) side of gas transfer membrane module 205, with vacuum levels of 25 inches of mercury typically used. Liquid flow is monitored with flowmeter 204. One complete turnover of the fluid in the canister would be achieved in less than 3 minutes at 30 gallons per minute flow for an 80-gallon canister (assuming about 15-20 gallons fluid displaced by the fuel assembly) and assuming about 10 gallons fluid in the recirculation system. The vacuum is achieved by (1) operating vacuum pump/blower 301, (2) discharging the effluent through open valve 302, (3) monitoring the radioactivity of the gas by a radiation detector 304, typically a beta scintillation detector, until background radiation significantly decreases or ceases to decrease, and (4) discharging gas from the detector to an exhaust line 305 through open valve 306. Optionally, a sweep gas is introduced via conduit 309 through valve 310 to assist in transport of air and radioactive noble gas species out of the gas transfer membrane module. The sweep gas should not be air or Xe or Kr, as the efficiency of the gas transfer membrane module is best observed when the partial pressure difference of the gases between the liquid side and lumen side is greatest according to Henry's Law. In industry, air is a preferred sweep gas for dissolved gases such as CO₂, but not for removal of air from a liquid stream (see for example https://deionx.com/membrane-contactor-technology/). Further, one gas transfer membrane module supplier 3M specifically cautions against use of air as a sweep gas at temperatures above 30° C. (86° F.) to prevent degradation of the membranes—see “Important Operating Notes on Page 7 of “Liqui-Cel® Design and Operating Procedures” www-liquicell.com-now a 3M™ company. Argon or other inert gas would be a candidate sweep gas for the present system if sweep gas is used at all to be consistent with vendor recommendations. Pure nitrogen can also be used as the sweep gas as it has the lowest Henry's law constant among the gases among the gases argon, oxygen and nitrogen, as long as vacuum is applied in concert with use of nitrogen as a sweep gas (so called “combo” mode).

Referring to FIG. 2B, the degassing procedure in closed loop recirculation mode is performed using the steps of opening valves 209 and 207, operating fluid pump 201, and applying vacuum to the lumen (gas) side of gas transfer membrane module 205. As in once-through mode, flow is monitored by flowmeter 204. As in once-through mode, vacuum is achieved by (1) operating vacuum pump/blower 301, (2) discharging the effluent through open valve 302, (3) monitoring the radioactivity of the gas by a radiation detector 304, typically a beta scintillation detector, until background radiation significantly decreases or ceases to decrease, and (4) discharging gas from the detector to an exhaust line 305 through open valve 306. Optionally, a sweep gas is introduced via conduit 309 through valve 310 to assist in transport of air and radioactive noble gas species out of the gas transfer membrane module. Optionally, two different sweep gases may be used sequentially such as nitrogen to initially degas the fluid and then argon to increase the level of degassing.

Optionally, in the degassed fluid in recirculation mode can be cooled to remove decay heat by cooler 206 during the degassing process.

Further optionally in either mode, the gas supplied to the detector is dried using dryer 303 (dehumidified) to remove moisture in the gas prior to it entering the radiation detector to improve the sensitivity of the detector.

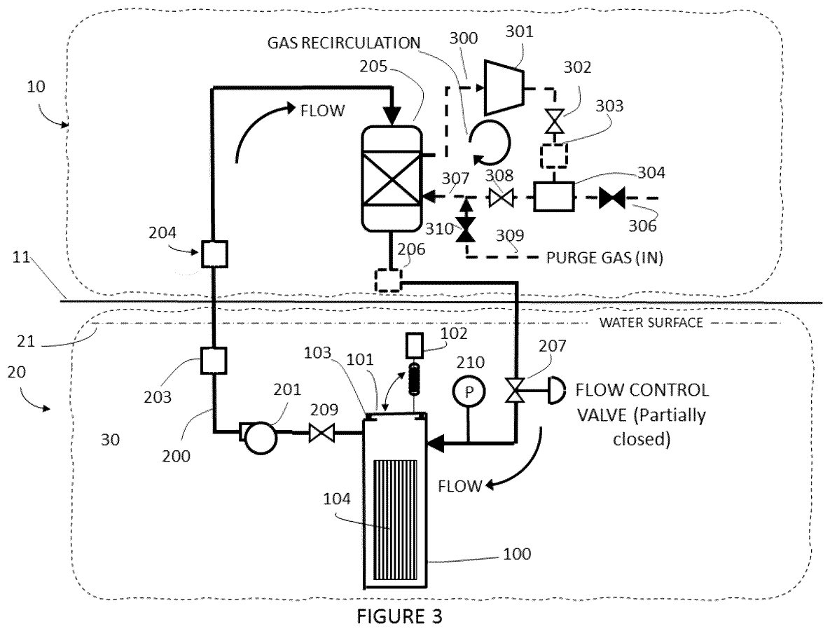

Step 3. Referring to FIG. 3, a sipping procedure is performed by reducing the pressure in the canister 100 causing radioactive noble gases to be released from the interior of the defective fuel rods. Flow through the recirculation loop 200 is established by opening valves 209 and 207 and operating pump 201 while monitoring flow with flowmeter 204. Fluid passes through filter 203 and is passed through the gas transfer membrane module 205. Non-radioactive or clean gas may be added to loop 300 by admitting gas through valve 310 from purge gas source 309 to lower background radiation in the gas loop 300 prior to a sipping test. Valve 310 is then closed. Vacuum is applied to the lumen side of the gas transfer membrane module using vacuum pump blower 301 in the gas loop 300 with valve 302 open. The gas may be dried/dehumidified with optional dryer 303. Gas in the gas loop is then recirculated back to the gas transfer membrane module by opening valve 308 and closing valve 306. Valve 310 remains closed as sweep gas is not used in the sipping test as it would only dilute any radioactive noble gas removed in the gas transfer membrane module 205 which would make it more difficult to detect small leaks in defective fuel. Once a closed loop flow of gas is established in gas loop 300 and fluid from the canister continues to recirculate through fluid loop 200 using pump 201, valve 207 is partially closed. Partially closing this valve increases the pressure drop across the valve. The valve may be closed to the point at which the fluid just downstream of the valve begins to cavitate as the pressure approaches the vapor pressure of the fluid. For water at 105° F. (40° C.) this is about 1 psia (−13.7 psig). Pressure can be monitored by a pressure gauge or pressure transducer 210. Assuming the top of the canister is under about 20 ft. of water, the initial pressure at the top of the canister would be about 23 psia (8.7 psig). So the pressure would be reduced by about 95%. However, the net positive suction head (NPSH) requirement of the pump and additional pressure losses in the recirculation system and canister between valve 207 and the pump may limit the degree to which valve 207 can be closed resulting in a pressure of about 2 to 3 psia at the top of the canister. This is similar to the pressure targets used in conventional vacuum sipping systems. Being a closed (solid) recirculation system 200, and given the incompressible nature of the fluid, the pressure in the canister decreases in concert with pressure decrease downstream of valve 207 which can be less than one minute and as short as a few seconds depending on the valve 207 closing time. The pump suction-induced pressure reduction causes radioactive noble fission gases to be released into the recirculating fluid and convectively transported to the gas transfer membrane. Convectively moving released noble gases from the fluid around the fuel to the degassing system as radiation detector means (1) that effectively all released dissolved gas can be measured if removed by the gas transfer membrane module, and (2) the time required for the gases to be transported to the detector is much faster that that associated with waiting for bubbles to rise up through the canister or diffuse through the liquid in the canister of a conventional vacuum sipping system. Further, the gases are not diluted by the gas in the headspace of a conventional vacuum sipping system. If the pump speed and therefore the fluid flow rate in loop 200 is increased to compensate for the increased pressure drop through valve 207, the time required to detect a leak would be about 2 minutes assuming an 80-gallon system with a 30 gallon per minute flowrate and about 40 ft of 1-inch hose used to construct the fluid recirculation system 200 between the canister and the gas transfer membrane module. Once removed in the gas transfer membrane module 205, the noble gases continue to accumulate in loop 300. As such, the system operates as an integrating or “integral” radioactive noble gas detection system which for very small leaks is more sensitive than detection in a flowing stream discharged to atmosphere, especially if a sweep gas is used, which would dilute the fission gases.

Step 4. A sipping test is completed by reopening valve 207, optionally terminating fluid recirculation through system 200 by stopping pump 201, purging any accumulated radioactive fission gases from the gas loop 300 by adding gas through the purge gas system 309 and discharging the purge gas through valve 306 to an exhaust. The lid of canister 101 can then be opened with actuator 102 to allow fuel 104 to be removed from the canister.

### Example

An additional capability of the present invention is to take one or more liquid samples and collect them in sample vessel 503 and analyze the liquid sample for non-volatile fission products such as Cs-137.

Alternatively, one may collect non-volatile fission products such as Cs-137 in sample vessel 503 that has been prefilled with a solid material 504 that absorbs or adsorbs Cs-137 such as a crystalline silicotitante (CST) and analyze the CST-containing sample vessel for radioactivity.

### Example

Another additional capability of the present invention is to collect volatile radioactive noble gases removed from loop 200 during a sipping test and discharged out of vacuum pump/blower 301 through open valve 311 in a vessel 312 in the using an absorbents selected from a group that includes activated charcoal, molecular sieve or a zeolite.

One skilled in the art will appreciate that the present invention improves over existing systems because at no time is gas added to the system either by (1) sparging or (2) creating a gas space above the fuel as is done in conventional vacuum sipping, either of which can cause dilution of the radioactive fission gases and decreased sensitivity of the system. Further, operating in what has been described as integral mode increases the sensitivity of the system by analyzing the total amount of fission gas that is released from a defective fuel rod or rods as opposed to only the amount that sweeps by the detector at any point in time.

The present invention also increases the sensitivity of the sipping process by initially degassing the system of air without using air as a sweep gas. The volume of dissolved air that would be released out of the fluid by the pump suction induced pressure reduction would be a further cause of dilution of the radioactive fission gases released from defective fuel. Enhanced removal of air is achievable by using a gas other than air as the sweep gas in the gas transfer membrane module.

It will be appreciated that the system may include redundant components to increase reliability, and may employ more than one component such as two or more gas transfer membrane modules in series or parallel to increase capacity of for other purposes.

Another modification of the present invention is to further increase the sensitivity of the system by incorporating means of reducing background dose rates by means other than degassing. More specifically, when radioactive fission gases such as Xe-133 or Kr-85 are present in the sipping system or being released from defective fuel, they may (1) dissolve in the fluid present in the sipper, (2) come out of solution as bubbles, or (3) adsorb to solid surfaces such as stainless steel or plastics such as the plastic window of a beta scintillation detector that can detect radioactive noble gases.

In the first phenomenon above, degassing methods for removing dissolved gases contributing to background radiation levels have already been presented.

In the second phenomenon above, it is well known that fluids with dissolved gases that come out of solution can form bubbles, typically with diameters 0.1 to 0.2 cm (1 to 2 mm) [see Wu, M, and M. Gharib, “Experimental Studies on the Shape and Path of Small Air Bubbles Rising in Clean Water”, Physics of Fluids, Volume 14, Number 7, pp L49 to L52, July 2002]. Larger bubbles can also form and generally do not stick to surfaces but rise through the fluid due to buoyancy forces being greater than surface adhesion forces.

Small bubbles of radioactive noble gases can also form at the mouth of defects in defective nuclear fuel rods as the pressure is lowered during sipping. If these bubbles do not rise up through the canister, they can stick to surfaces of the canister 100, or the walls of components in the fluid recirculation system 200. Periodic and random detachment of the bubbles from surfaces containing radioactive noble fission gases can result in spikes in background radiation doses and interfere with the detection of defective fuel during a sipping test.

### Example

In the present invention, one approach is to fabricate the canister and recirculation system with components where the wetted surfaces are rendered hydrophilic which reduces the tendency for bubbles to attach to the surfaces.

An example of a coating that is hydrophilic is titanium dioxide (TiO₂). TiO₂ can be applied by several techniques including sputtering or chemical vapor deposition. TiO₂ coatings are used by most major glass manufactures to render the glass self-cleaning (see for example the summary in https://en.wikipedia.org/wiki/Self-cleaning_glass). TiO₂ coatings on glass are on the order of 4 to 20 nm thick.

Other hydrophilic coatings such as N-methyl-2-pyrrolidone are used to modify the surface of medical devices to render them hydrophilic (see https://www.coatings2go.com/).

Proprietary hydrophilic coatings are also offered by companies such as Acculon specifically to prevent bubbles from sticking to surfaces (see https://www.aculon.com/hydrophilic-borosilicate-glass). The thickness of these coatings is on the order of 4 nm.

In the present invention, one or more of these coatings may be used to treat the wetted surfaces of the sipping system, including metallic surfaces and non-metallic surfaces such as the inner diameter of fluid hoses, to prevent attachment of bubbles containing radioactive noble gases to the surfaces. It is noted that these coatings are not needed to treat the gas transfer membrane module hollow polymer porous fibers, as the fibers are already in a hydrophobic state to prevent water transport through the fiber pores.

Regarding the third phenomenon, the absorption of radioactive noble gases which causes contamination of components such as the beta scintillation detector, the detection of radioactive noble gases is also required worldwide for nuclear weapons testing compliance verification [see Seifert, C. E, et al., “Mitigation of Memory Effects in Beta Scintillation Cells for Radioactive Gas Detection”, 27th Seismic Research Review: Ground Based Nuclear Explosion Monitoring Technologies, Pacific Northwest National Laboratory, DOE Contract No. DE-AC05-76RL01830, September 2005]. This reference states: “ . . . tests of the . . . system have shown that latent radioactivity remains in the plastic cells after evacuation of the gases, leading to a “memory effect” in which the background count rate is dependent on the sample history.” As described in this reference, the memory effect is due to both adhesion of the gas to surfaces or diffusion of noble gases into the plastic cell walls. The issue is mitigated by depositing a thin layer of metal on the plastic surface, in this case aluminum.

Other options for coatings of the plastic scintillation detectors are available [see Blackberg, Lisa, “Surface Coatings as Xenon Diffusion Barriers on Plastic Scintillators—Improving Nuclear-Test-Ban Treaty Verification” Department of Physics and Astronomy 2011 Uppsala University, Uppsala Sweden (2011)] where it is reported that a 425 nm thick aluminum oxide coating reduced the memory effect by a factor of 1000.

Finally, the absorption of noble gases including xenon and krypton on surfaces of analytical equipment such as the interior of gas chromatography (GC) columns compromises the analysis of these species. To prevent absorption, coatings such as amorphous silicon dioxide (α-SiO²) are applied to the inner surface of GC columns, such as SilcoNert™ from SilcoTek™ (Silcotek, Bellefonte, PA). This same type of coating can be applied to the plastic surfaces of the beta scintillation detector and also other inner surfaces of the gas loop 300.

In the present invention, coatings are applied to surfaces of the radiation detector 304 and/or the gas loop 300 to prevent absorption on the surfaces of or diffusion into the components.

A final means of reducing the absorption of radioactive noble gases is to pull a higher level of vacuum on gas loop 300 as would normally be used to extract noble gases from the fluid loop 200. Normal vacuum requirements for the gas transfer membrane is about 25 inches of mercury or 125 Torr absolute. In the present invention, a high vacuum pump would be used for vacuum pump 301 or a separate pump installed to pull a vacuum as great as a few mTorr.

The examples discussed herein are provided to illustrate the structural and functional principals of the invention and are not intended to be limiting. In particular, although several systems are described herein as “recirculating”, it will be appreciated that in some cases, the recirculation system valves and conduits may be operated in what would be called “once-through” mode, and as such are not recirculating the fluid at that moment. Those skilled in the art will understand that naming a fluid system as a “recirculation system” but operating occasionally in once-through mode is a common terminology practice in the power industry. For example, the “primary coolant recirculation system” in a boiling water reactor is also used to fill and drain the primary cooling system in a once-through mode.

### Summary of Various Aspects of the Invention

In accordance with some aspects of the invention, a method is disclosed to combine the aforementioned pressure reduction strategy with means of first reducing the background radioactivity of the of the fluid in the canister prior to a sipping test by passing fluid from the recirculation system through a gas transfer membrane module operated under vacuum on the hollow fiber lumen side of the module before returning the degassed fluid to the canister after flowing through the shell side of the module. The fluid may be drawn from the pool or from the canister, and recirculated or discharged to the pool after passing through the canister. After the level of pre-existing radioactive gases has been reduced, a second flow loop is activated and while pressure is or has been reduced in the canister the degassing module extracts radioactive noble gases released from defective fuel. The degassing module may be the same for both stages of the process, or two separate modules may be used.

The exhaust from the degassing module during the removal of pre-existing gases is preferably passed through a radiation detector downstream of the vacuum pump/blower to monitor the progress of stripping out the pre-existing species. The exhaust from the degassing module during the actual sipping test is likewise passed through a radiation detector, to quantify the amount of radioactive gas newly released from the fuel as a result of the sipping procedure. In most cases it is preferred that the same radiation detector performs both of the aforementioned functions.

In some cases, the gas passing through the detector may be directed out of the apparatus to a suitable discharge point such as the plant's radioactive offgas handling system.

Alternatively, the gas passing through the radiation detector may be directed back to the inlet of the degassing module in a gas loop that accumulates radioactive fission gases, which allows for an integrated measurement of radiative noble gas release from defective fuel.

The degas module and gas loop may be purged with non-radioactive gas to remove residual or accumulated radiative fission gases prior to a subsequent sipping test.

One or more examples of the invention may include a canister with a sealable lid; a liquid recirculation loop with a pump and valves; a degassing system with integral radiation detector; and a purge gas system.

The wetted surfaces of selected components may be treated with one or more coatings to render the surface less susceptible to adsorption of dissolved gases such as xenon and krypton. Such coatings may also be employed to render the surface less susceptible to physical attachment of bubbles containing gases such as xenon, krypton or air.

1. A canister sipping system for detecting defects in nuclear fuel, comprising:
a canister to hold a nuclear reactor fuel rod assembly submerged in an aqueous fluid;
a first recirculation system to pump fluid from the canister through a gas transfer membrane module to strip the fluid of pre-existing dissolved radioactive gases and air, in which:
a gas conduit including a pump and valve directs gas stripped in the gas transfer membrane module to a radiation detector to monitor the progress of removing the pre-existing radioactive gases;
a second recirculation system to pump the degassed fluid through a gas transfer membrane module, in which:
the second recirculation system includes a restrictor valve upstream of the canister and downstream of the pump discharge on the high pressure (high-P) side of the pump, so that when the valve is partially closed it creates a partial vacuum in the canister with pump suction to extract radioactive gases from any defective fuel rods, and,
a valve and gas conduit directs gases from the gas transfer membrane module to a radiation detector when the second recirculation system is operating, in order to monitor any increase in radioactive gases extracted from defective fuel elements by the partial vacuum.

2. The system of claim 1 wherein the aqueous fluid comprises a fluid selected from the group consisting of: water, demineralized light water, heavy water, and borated light water.

3. The system of claim 1 wherein the canister comprises a sealable lid and an actuator to open the lid when a fuel assembly is moved in and out and close the lid during testing.

4. The system of claim 1 wherein the first recirculating system further comprises at least one component selected from the group consisting of: filters, flowmeters, pressure gauges, pressure transducers, and coolers.

5. The system of claim 4 wherein the cooler comprises a submerged finned heat exchanger transferring heat to the pool of surrounding fluid in which the canister is submerged.

6. The system of claim 1 wherein the gas transfer membrane module comprises a hollow fiber gas transfer membrane assembly.

7. The system of claim 6 wherein a vacuum is applied to the lumen side of the hollow fiber membrane assembly to extract dissolved gases from fluid passing through the shell side of the membrane assembly.

8. The system of claim 1 wherein the radiation detector comprises a beta scintillation detector.

9. The system of claim 1 wherein the preexisting radioactive gases and the extracted radioactive gases comprise at least one species selected from the group consisting of: Kr-85 and Xe-133.

10. The system of claim 1 further comprising a source of sweep gas to improve the efficiency of removing dissolved gases from the shell side of the gas transfer membrane module.

11. The system of claim 1 further comprising a fluid sampling system to detect the presence of Cs-137 released from the fuel assembly.

12. The system of claim 1 wherein the radioactive gases removed from the defective fuel are recirculated back to the gas transfer membrane module in a third closed loop gas filled recirculation loop that accumulates the radioactive gases.

13. A method for detecting defects in a nuclear fuel rod assembly comprising the steps of:
a) placing a fuel rod assembly vertically in a closed, water-filled canister;
b) establishing a first recirculation loop to pass the canister water through a gas transfer membrane module to remove pre-existing radioactive gases from the water;
c) pumping gas from the gas transfer membrane module to a radiation detector to monitor the progress of removal of pre-existing radioactive gases;
d) after removal of the pre-existing radioactive gases, establishing a second recirculation loop including a pump and a restrictor valve so that the canister is on the low-pressure (low-P) leg and the gas transfer membrane module is on the high-pressure (high-P) leg;
e) pumping gas from the gas transfer membrane module to a radiation detector; and,
f) evaluating the level of fuel defects based on the level of radioactivity detected in the gas.

14. The method of claim 13 further comprising the step of:
g) introducing a sweep gas into the first recirculation loop to improve the efficiency of removing dissolved gases from the shell side of the gas transfer membrane module.

15. The method of claim 13 further comprising the step of:
h) collecting a fluid sample to detect the presence of Cs-137 in the recirculating fluid.

16. The method of claim 13 wherein the radiation detector comprises a beta scintillation detector.
